(19) United States
(12) Patent Application Publication
(10) Pub. No.: US 2007/0279479 A1
(43) Pub. Date: Dec. 6, 2007

(54) Information Recording Drive, Information Recording Media and Detection Method of Deterioration Situation of Information Recording Media

(76) Inventors: Akemi Hirotsune, Saitama (JP); Harukazu Miyamoto, Higashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/754,416

(22) Filed: May 29, 2007

(30) Foreign Application Priority Data
Jun. 2, 2006 (JP) 2006-154170

(51) Int. Cl. B41J 2/435; G01D 15/14

(52) U.S. Cl. 347/224

(57) ABSTRACT

To know whether recorded data has been deteriorated. In an information recording medium recording data in a data recording layer through a change in atom arrangement caused by energy radiation, monitor marks are being recorded in the data recording layer to monitor a deterioration situation. A user can know the deterioration situation of recorded data.

### INCORPORATION BY REFERENCE

The present application claims priority from Japanese application JP2006-154170 filed on Jun. 2, 2006, the content of which is hereby incorporated by reference into this application.

### BACKGROUND OF THE INVENTION

1. Field of the Invention

The present invention relates to a drive for recording monitor marks which indicate a deterioration situation of data recorded in an information recording medium, an information recording medium recorded with monitor marks, and a method of detecting a deterioration situation of the information recording medium recorded with monitor marks.

2. Description of the Related Art

An optical disk as an information recording medium has a main feature that the optical disk itself can be dismounted from a recording/reproducing apparatus and a user can move to another place by holding the optical disk. In this case, the record data is deteriorated depending upon the preservation environment of the optical disk such as exposure to sun light and preservation at a high temperature place. However, the user cannot know whether the record data has been deteriorated.

An example of an optical disk whose data is deteriorated is described in http://www.flexplay.com/. A special layer which is subjected to chemical reaction is provided on a light incidence side. When a security state is released, this layer changes from a transparent state to an opaque state so that data cannot be read. With this method, although a deterioration situation can be confirmed from a color change, data is deteriorated at the same time so that a user cannot know a deterioration situation before data is deteriorated.

A jitter or an error rate of a record mark recorded as data is used in some cases as an index representative of the quality of data. These indices can supply information on the quality of data, as described in “Optical Disk Technology” pp. 212 to 222 (1989). With this method, although a deterioration situation of data at the measurement time can be known, a user cannot know a deterioration situation before data is deteriorated. A method of determining a lifetime of an optical disk by checking data deterioration of an optical disk preserved under each of a plurality of temperature conditions and performing Arrhenius plotting and extrapolation is described in “Feasibility Study Report on Development of Optical Disk Media for Long Preservation, (Summary)” (March 2005) at http://www.dcaj.org/. With this method, it is possible to roughly estimate the time when data starts being deteriorated. However, it is not possible to correct at a high precision a difference of each of a plurality of disks manufactured by the same maker and an error caused by not correctly grasping the preservation environment of each disk.

### SUMMARY OF THE INVENTION

With these conventional methods, a user cannot know whether recorded data has been deteriorated so that the user cannot read data in some cases.

According to the present invention, monitor marks indicating a deterioration situation of record data are recorded in an optical disk. A user can know a deterioration situation by looking at the monitor marks. It is therefore possible for the user to make countermeasures for deterioration of record data, e.g. to back up the record data.

An information recording drive of the present invention is a drive for recording data in a data recording layer of an information recording medium through energy radiation, e.g., by changing an arrangement of atoms in the data recording layer, and has, for example, means for recording monitor marks in the data recording layer to monitor the deterioration situation.

If the monitor marks are recorded under a recording condition providing easier deterioration than the marks recorded for data recording, the monitor marks are deteriorated before the marks as the record data are deteriorated. It is therefore possible to know a lowered quality of record data. Since the deterioration situation can be known before the record marks are deteriorated (before the quality of record data lowers), a user can perform a countermeasure such as backup while the record data can be accessed.

The information recording drive may store a recording condition for monitor marks or may identify it from information in the information recording medium.

An information recording medium of the present invention is recorded with data in a data recording layer through energy radiation, e.g., by changing an arrangement of atoms in the data recording layer, and is recorded with monitor marks in the data recording layer to monitor the deterioration situation. It is therefore possible for a user to know the deterioration situation of data recorded in the information recording medium, i.e., record data.

The information recording medium is recorded with data in a data recording layer through energy radiation, e.g., by changing an arrangement of atoms in the data recording layer, and is recorded with monitor marks to monitor the deterioration situation of the data recording layer. It is therefore possible to detect the deterioration situation of the information recording medium by utilizing a change in the reflectivity of the monitor marks to be caused by deterioration. A user can know the deterioration situation of record data, i.e., record marks, from the detection results.

A set of monitor marks constitutes a figure, code, a symbol or a letter or a combination thereof. If such an element is disposed to become visual by deterioration, the figure, code, symbol or letter or a combination thereof appears to display the deterioration situation. If the figure, code, symbol or letter or a combination thereof constituted of a set of monitor marks is disposed to disappear by deterioration, the figure, code, symbol or letter or a combination thereof disappears to display the deterioration situation. If the figure, code, symbol or letter or a combination thereof constituted of a set of monitor marks is disposed to change its shape by deterioration, the deterioration situation can be know stepwise.

According to the present invention, it is possible to know the deterioration situation (a lowered quality of data) of record marks recorded in an optical disk.

### BRIEF DESCRIPTION OF THE DRAWINGS

FIGS. 1A to 1C are schematic diagrams showing an example of an optical disk of the present invention.

FIG. 2 is a diagram showing optical characteristics of each region of a medium recorded with monitor marks.

FIGS. 3A to 3C are conceptual diagrams showing a set of monitor marks checked with a reader.

FIG. 4 is a cross sectional view showing the structure of an optical disk of the present invention.

FIG. 5 is a schematic block diagram showing an example of an optical disk drive having a monitor mark recording function.

FIGS. 6A to 6D are photographs of monitor marks.

FIG. 7 is an illustrative diagram of a system controller.

FIG. 8 is a flow chart illustrating an example of a monitor mark recording process of the present invention.

FIG. 9 is a flow chart illustrating an example of a recording process.

FIG. 10 is an illustrative diagram showing an example of the relation between sector positions and a monitor mark recording coordinate system.

FIG. 11 is a diagram illustrating generation of monitor mark recording waveforms.

FIGS. 12A to 12C are schematic diagrams showing an example of recording monitor marks in an optical disk according to a second embodiment.

FIGS. 13A to 13C are schematic diagrams showing an example of recording monitor marks in an optical disk according to the second embodiment, in which monitor marks are displayed stepwise in accordance with a deterioration degree.

FIG. 14 is a schematic block diagram showing an example of an optical disk drive having a monitor mark reproducing function.

FIGS. 15A and 15B are diagrams showing an example of displaying a deterioration situation by an optical disk drive.

FIGS. 16A to 16F show a relation between a signal level and a change in monitor marks immediately after recording and after deterioration.

FIG. 17 shows a relation between a monitor mark and a signal level.

FIG. 18 shows a dependency of a monitor mark reflectivity upon a deterioration situation.

FIGS. 19A and 19B show a dependency of a monitor mark reflectivity upon a recording power immediately after recording and after deterioration.

FIGS. 20A and 20B show a dependency of a monitor mark reflectivity upon the number of recording times immediately after recording and after deterioration.

FIGS. 21A and 21B show a dependency of a monitor mark signal quality upon a recording power immediately after recording and after deterioration.

FIGS. 22A and 22B show a dependency of a monitor mark signal quality upon the number of recording times immediately after recording and after deterioration.

FIG. 23 shows another example of monitor mark recording positions.

FIGS. 24A and 24B show a dependency of a monitor mark reflectivity upon a recording power immediately after recording and after deterioration.

FIGS. 25A and 25B show a dependency of a monitor mark reflectivity upon the number of recording times immediately after recording and after deterioration.

FIGS. 26A and 26B show a dependency of a monitor mark signal quality upon a recording power immediately after recording and after deterioration.

FIGS. 27A and 27B show a dependency of a monitor mark signal quality upon the number of recording times immediately after recording and after deterioration.

### DESCRIPTION OF THE EMBODIMENT

Embodiments of the present invention will be described with reference to the accompanying drawings.

### First Embodiment

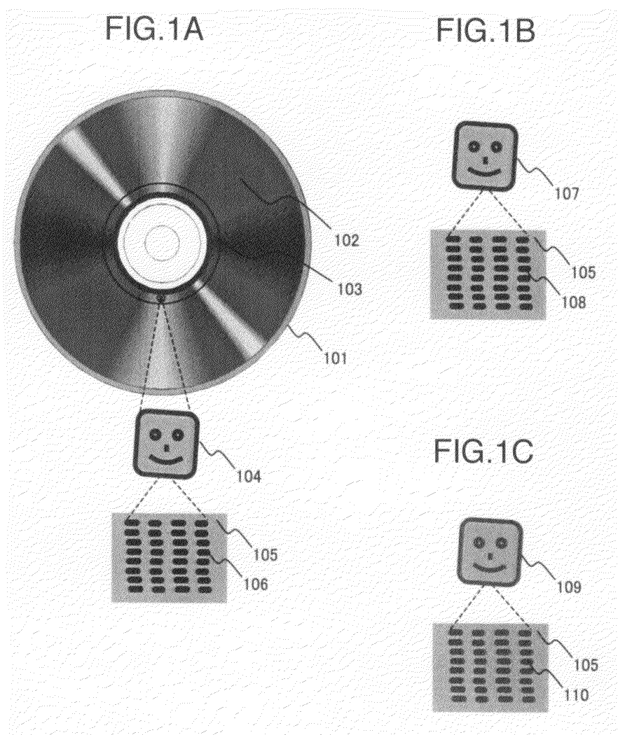

FIGS. 1A to 1C are schematic diagrams showing an example of an optical disk of the present invention. The optical disk 101 has a region 102 where data is recorded and a region 103 where monitor marks are recorded for grasping a deterioration situation. A monitor FIG. 104 was recorded while data was recorded or immediately before or after data recording. The monitor FIG. 104 immediately after data recording is made of a set of a number of monitor marks 106 in a space 105. In order to check the deterioration situation of the disk, the disk was left in a vehicle exposed to direct sun rays. The inside of the vehicle was heated to 150° C. at a maximum. FIG. 1B shows a monitor FIG. 107 after three months after the disk was left in the vehicle. The monitor FIG. 107 has a smaller difference of the reflectivity from that of the space 105 and has a smaller contrast. This is because the reflectivity of the monitor marks 108 constituting the monitor FIG. 107 becomes near the reflectivity of the space. FIG. 1C shows a monitor FIG. 109 after one year. The monitor FIG. 109 has a much smaller difference of the reflectivity from that of the space 105 and has hardly a contrast. This is because the reflectivity of the monitor marks 110 constituting the monitor FIG. 107 becomes generally the same reflectivity as that of the space. In this way, the deterioration situation of data can be judged by writing the monitor marks in a data recording layer of the optical disk. Data deterioration is dependent upon the type of information recording media, preservation conditions and the like. This method of writing the monitor marks in the data recording layer has a feature that a precision of deterioration situation judgment is very high because the data marks are written in the same data recording layer and the type of information recording media and the preservation conditions are the same. A difference of each disk and a preservation environment of the disk are reflected upon the deterioration degree of the monitor marks. The monitor marks start being deteriorated before record marks (data) are deteriorated. It is therefore possible to grasp a lowered quality of record mark (data) before the data is deteriorated. It is obviously possible to detect deterioration of the monitor marks even if the monitor marks are formed in a different layer. In this case, a precision was reduced more than when the monitor marks were formed in the same layer. As the figure is made of a set of monitor marks, the figure can be visually recognized without using a special apparatus and can be made very simple.

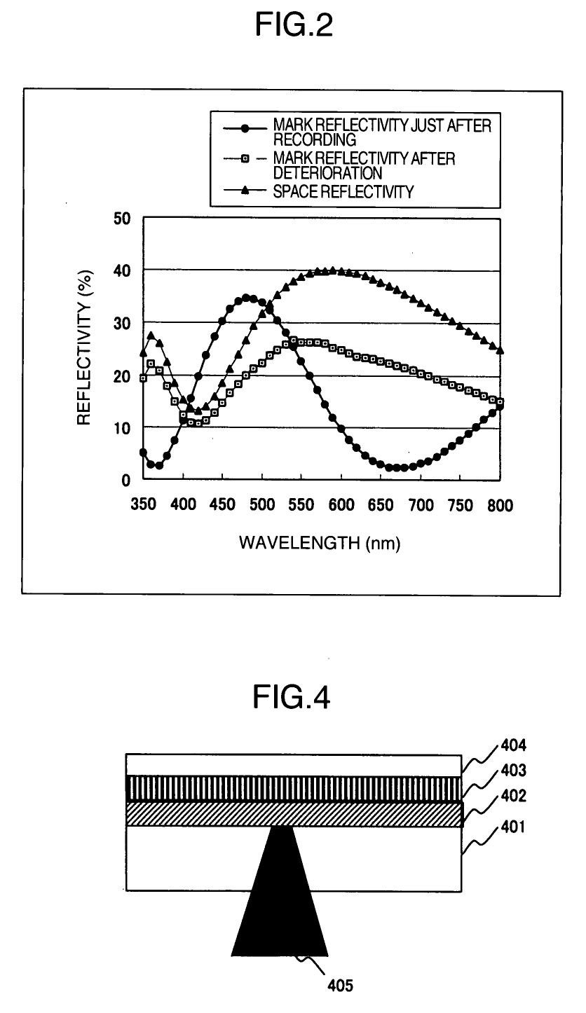

FIG. 2 shows optical characteristics of each region immediately after the monitor marks are recorded without any gap therebetween and after the deterioration (left one year and three months). An average reflectivity of the region having a diameter of about 5 mm was measured with a spectrometer. The monitor figure can be confirmed from a contrast formed by a difference between a mark reflectivity and a space reflectivity immediately after recording. To visually confirm the monitor figure, it is necessary to form a contrast in a visible wavelength range. In this medium, although a difference between the mark reflectivity and space reflectivity is almost 0 near at the wavelengths of 500 nm and 410 nm, there is a difference in the other visible wavelength range so that the figure can be recognized visually.

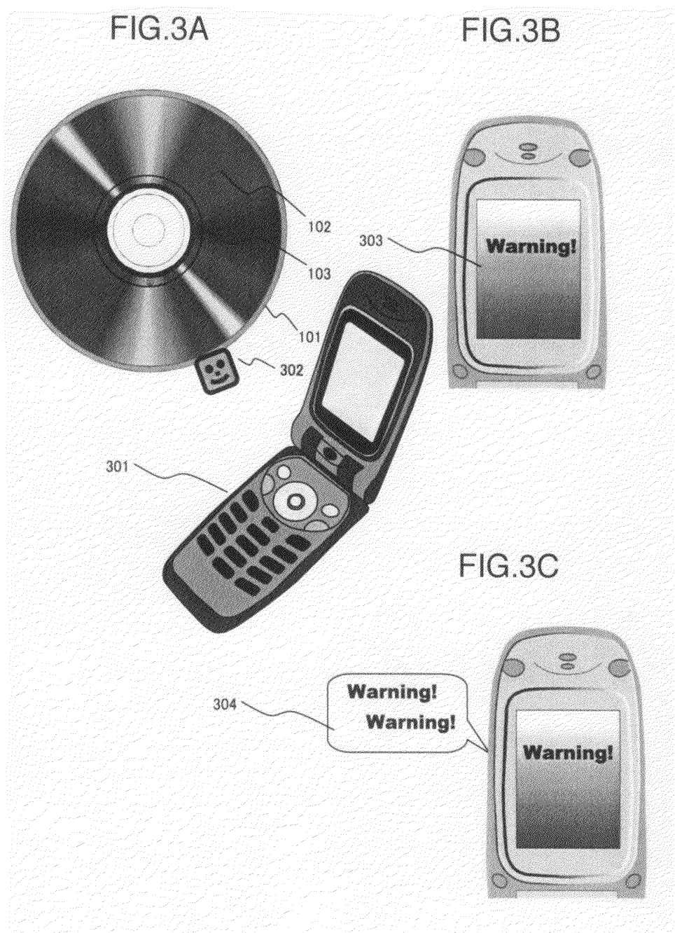

As shown in FIGS. 3A to 3C, if a dedicated reader 301 is used instead of naked eyes, it is important that there is a reflectivity difference in a detection wavelength range of the reader. Since this medium has the reflectivity difference excepting near the wavelengths 500 nm and 410 nm, it is possible to detect the deterioration situation with a color camera having a magnification function or the like. A deterioration situation may be confirmed by a user by displaying a monitor FIG. 302 itself, or a result 303 of judging a reflectivity distribution from the figure. A user may be notified by using sounds or voices 304. If a dedicated reader is used instead of visual recognition, the deterioration situation can be detected even if the size of the set of monitor marks is smaller than that of a visual recognition figure, code, a symbol, a letter or a combination of these, if the reader detection resolution is accompanied with a magnification function. It is therefore possible to display the medium deterioration situation in a small area of the information recording medium.

FIG. 4 is a schematic diagram of a cross sectional structure of an information recording medium. A recording laser 405 is irradiated upon a data recording layer 402 via a substrate 401, the data recording layer changing an atomic arrangement upon energy radiation.

The optical disk 101 was manufactured in the following manner. On the transparent substrate 401 having a tracking groove or pattern, the data recording layer 402 and a metal reflection layer 403 were formed which are made of ZnS—SiO₂, Ge—Sb—Te and ZnS—SiO₂. A protective substrate 404 was bonded by using UV curing resin to assemble the medium. Thereafter, initial crystallization was conducted.

Data and monitor marks are recorded in the medium by irradiating a high power laser beam to change from the crystalline state to the amorphous state. The recorded data and monitor marks may be erased.

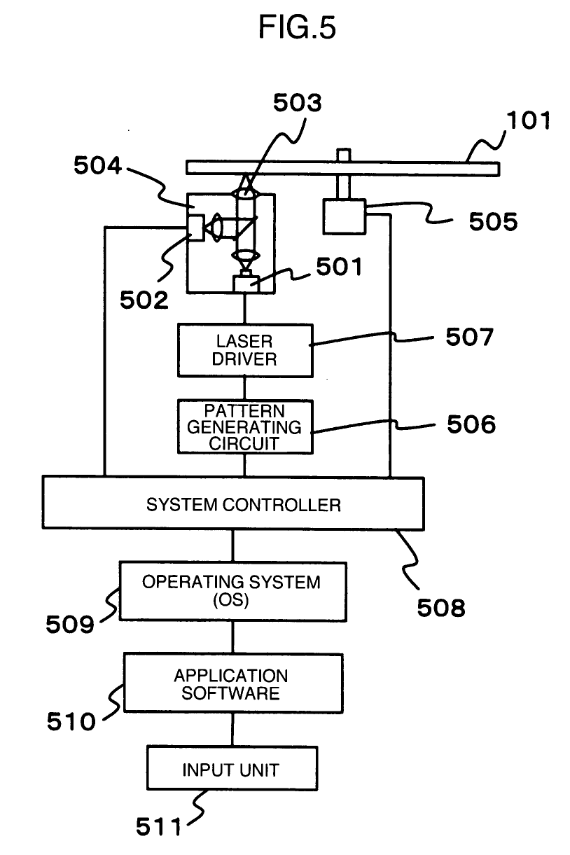

FIG. 5 is a schematic block diagram showing an example of an optical disk drive having a monitor mark recording function according to the present invention. For the convenience of description, the drive is shown with the optical disk 101 loaded therein. The optical disk 101 is essential for writing information therein. When necessary, the optical disk 101 may be dismounted from or mounted on the optical disk drive.

The optical disk drive is constituted of: an optical head 504 being movable in a radial direction of the optical disk 101 and equipped with a semiconductor laser 501, a photodetector 502, and an objective lens 503; a motor 505 for driving and rotating the optical disk 101; a laser driver 507 for driving the semiconductor laser 501 in accordance with a pattern formed by a pattern generating circuit 506; a system controller 508 for controlling the whole drive; an operating system 509; application software 510 and an input unit 511 for inputting an instruction of whether monitor marks are to be recorded. Although not shown, the optical head 504 is provided with an actuator to control the position of the objective lens 503 along an optical axis direction and along a direction perpendicular to the optical axis direction, for auto focusing and tracking, and with a servo controller for generating an actuator drive signal in accordance with a detection signal from the optical head 504.

An optical disk is loaded in the optical disk drive having a function of recording monitor marks indicating a deterioration situation, and the upper level controller such as the application software 510 and operating system 509 sends, via the input unit 511, the information on a monitor mark record instruction, a type of monitor marks, a record position and the like. Thereafter, the system controller 508 positions a focal point of the laser beam emitted from the optical head 504 at a proper position of a figure writing layer of the optical disk 101, drives the laser driver 507 in accordance with a write pattern to write a figure. A default of recording monitor marks at a designated position may be set so that a user is not necessary to enter an instruction each time the drive is activated.

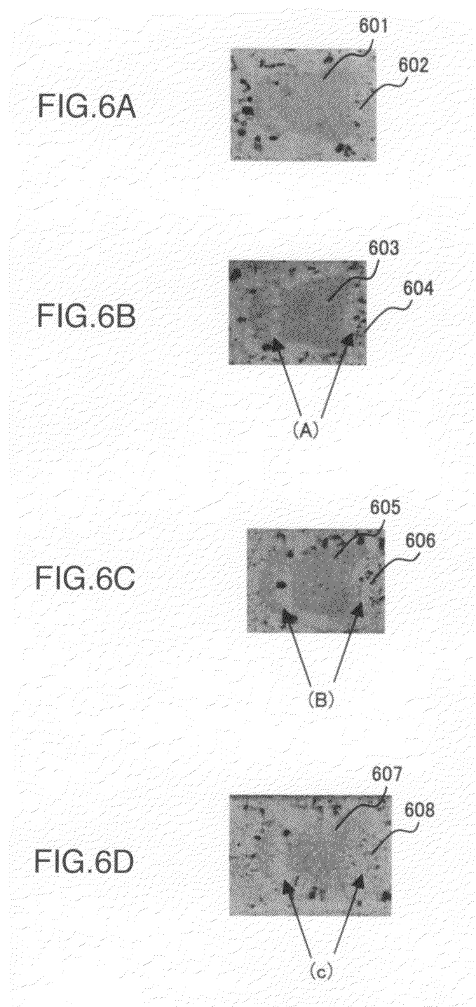

Description will be made on the principle why deterioration causes a reflectivity change. FIGS. 6A to 6D are photographs of one monitor mark observed with a transmission type electron beam microscope. With this observation method, marks 601, 603, 605 and 607 are colored in gray indicating amorphous. Mark peripheral areas 603, 604, 606 and 608 are colored in a plurality of color clusters indicating crystalline. This is because an electron beam is diffracted in accordance with an angle between a crystal orientation and an observation electron beam. FIG. 6A shows a monitor mark immediately after recording, and FIGS. 6B to 6D show observation results of a different shape of the monitor mark after deterioration and recorded under different recording conditions.

It can be seen from these photographs that the mark area in the amorphous region is made narrower than immediately after recording (FIG. 6A) because deterioration forms crystals in the gray area indicating the amorphous region. It can be seen further that the amorphous region is crystallized as the number of recording times increases from “100” (FIG. 6B), to “1000” (FIG. 6C) and to “10000” (FIG. 6D) and that the mark area is narrowed and an area ratio is likely to be changed. This change amount by deterioration changes with the recording condition. Since the amorphous region and crystalline region have different reflectivities, an average reflectivity changes as the area ratio between the amorphous region and crystalline region changes with deterioration, and becomes near the reflectivity of the crystalline region. As the average reflectivity of the area where the monitor marks are recorded changes, a reflectivity of a figure, code, a symbol, a letter or a combination of these as the set of monitor marks becomes near that of the nearby area so that the contrast becomes small and the marks become hard to be recognized. As the contrast becomes much smaller, marks cannot be recognized with naked eyes.

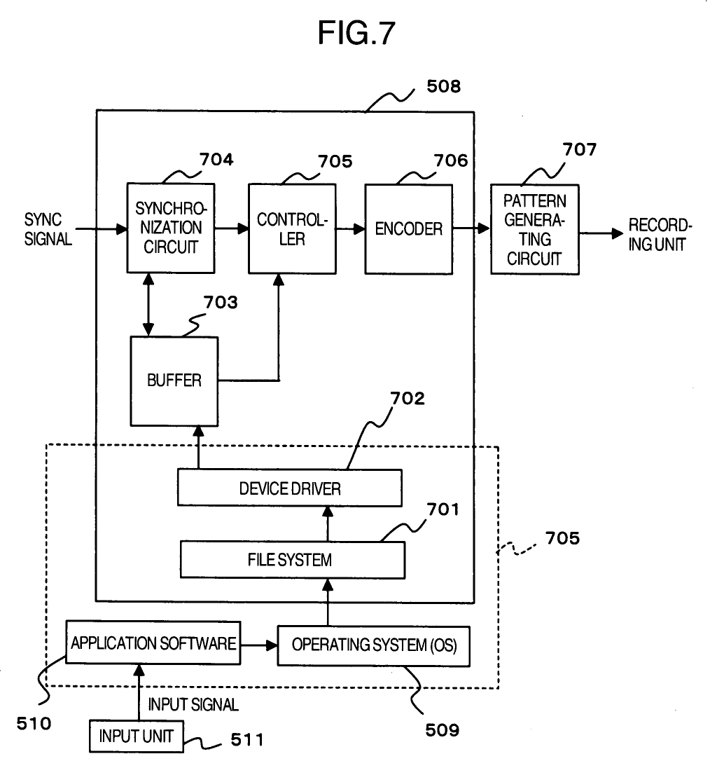

FIG. 7 is an illustrative diagram of the system controller 508 for controlling the whole drive. In response to an input signal from the input unit 511, the monitor mark recording condition recorded in the application software 510 is passed to a file system 701 of the system controller 508 via the operating system 509, and loaded in a buffer 703 via a device driver 702. The functions of the application software 510, operating system 509, file system 701 and device driver 702 surrounded by a broken line 705 in FIG. 6B are realized by software. This software is different from the software of a general optical disk drive for performing only data recording and reproducing, in that functions are added including “a function of distinguishing between a data recording area and a monitor mark recording area and managing these areas” and “a function of distinguishing between a data recording condition and a monitor mark recording condition and managing these conditions”. The file system 701 or device driver 702 are in charge of these functions. These recording conditions may be recorded not in the application software but in the information recording medium, or may be obtained from learning each time the drive is activated, or may be recorded in the drive. In accordance with the recording condition, while a synchronization circuit 704 ensures synchronization, the recording condition is sent to a controller 705. This recording condition is encoded by an encoder 705, and a pattern generating circuit 707 generates a recording pattern. The generated pattern is sent to a recording unit to be recorded in the information recording medium.

The optical disk drive having a monitor mark recording function of the present invention has a correspondence table between sector layout information and monitor recording coordinate values for each type of formats of the data recording region and monitor mark recording region of a disk, or generates format information at initial writing.

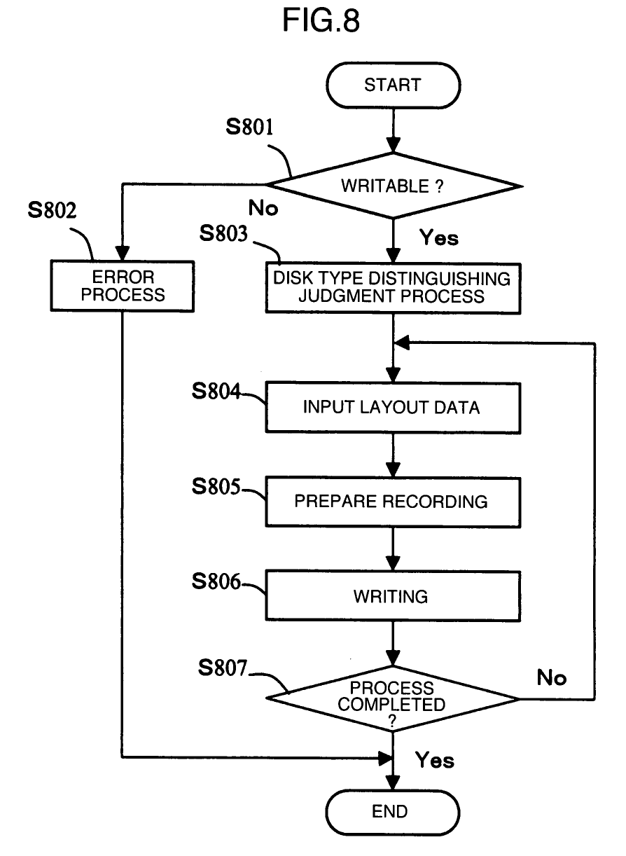

FIG. 8 is a flow chart illustrating an example of a process of writing visible monitor marks in an optical disk. As a disk is loaded and the power source of the drive is turned on, first a distinguishing process is executed to judge whether the disk can record monitor marks (Step 801). If a ROM disk, a disk having specifications not conformity with the drive or the like is loaded, it is judged that the disk is not writable and an error process is executed (Step 802). If monitor marks can be recorded in the disk, next a disk type distinguishing process is executed (Step 803). The disk type distinguishing process obtains a correspondence between layout coordinates of the monitor marks and a sector arrangement of the optical disk. Next, monitor mark recording data is input (Step 804). As the data is input, a recording preparation (Step 805) is conducted, and thereafter data of a figure, code, a symbol and a letter is written (Step 806). After the monitor marks are recorded, if there is still input data, the flow returns from Step 807 to Step 804 to repeat the above-described process, whereas if there is no input data, the process is terminated.

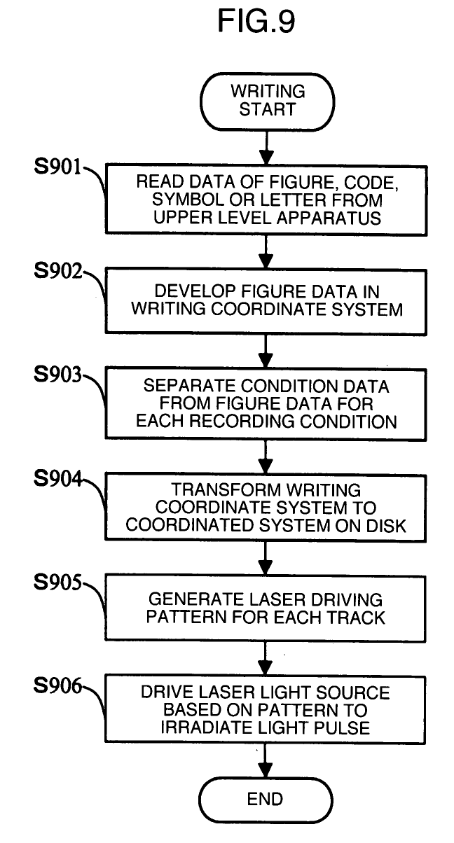

With reference to FIG. 9, detailed description will be made on a process of writing a figure or the like constituted of a set of monitor marks. After a writing starts, data of a figure, code, a symbol or a letter is read from an upper level apparatus (Step 901). A figure, code, a symbol, a letter or the like is hereinafter collectively called a figure. Next, the read figure data is developed into a data writing coordinate system (Step 902). Color condition data is separated from the figure data for each writing condition (Step 903). The writing coordinate system is transformed into a coordinate system on an optical disk (Step 904). In accordance with shape data and condition data developed on the coordinate system on the optical disk, a laser driving pattern for each track is generated (Step 905). The laser driving pattern is generated in such a manner that a laser radiation energy and/or the number of radiation times becomes different for each recording condition. The recording condition may be read from uneven information recorded in the medium, may be read from a database for each medium type stored in the information recording drive, or may be obtained from record learning after the medium is loaded in the information recording drive. The recording condition determined by these methods may be recorded in a medium and read when data is written next. The recording condition of monitor marks is determined by any one of these methods. In accordance with the laser driving pattern, the laser light source is driven to irradiate a light pulse in a monitor mark writing area of the data layer of the optical disk (Step 906) to thereby write monitor marks in the optical disk. Data can be written even if the order of Steps 902 and 903 is reversed, the order shown in FIG. 9 executes the process faster.

A writing preparation and writing process for a figure constituted of a set of monitor marks is executed under the control of the system controller 508 (FIG. 7). A figure writing preparation process is a process of moving the optical head to a figure writing position on the optical disk, encoding the writing contents and writing condition and transmitting the data to the recording unit. As shown in FIG. 7, as an input signal containing the writing contents and address information indicating a writing start position of the optical disk is sent to the system controller 508, the input signal is loaded in the buffer 703 and sent to the controller 705. The controller 705 sends synchronously the synchronization signal output from the synchronization circuit 704 and the input signal from the buffer 703 to the encoder 706.

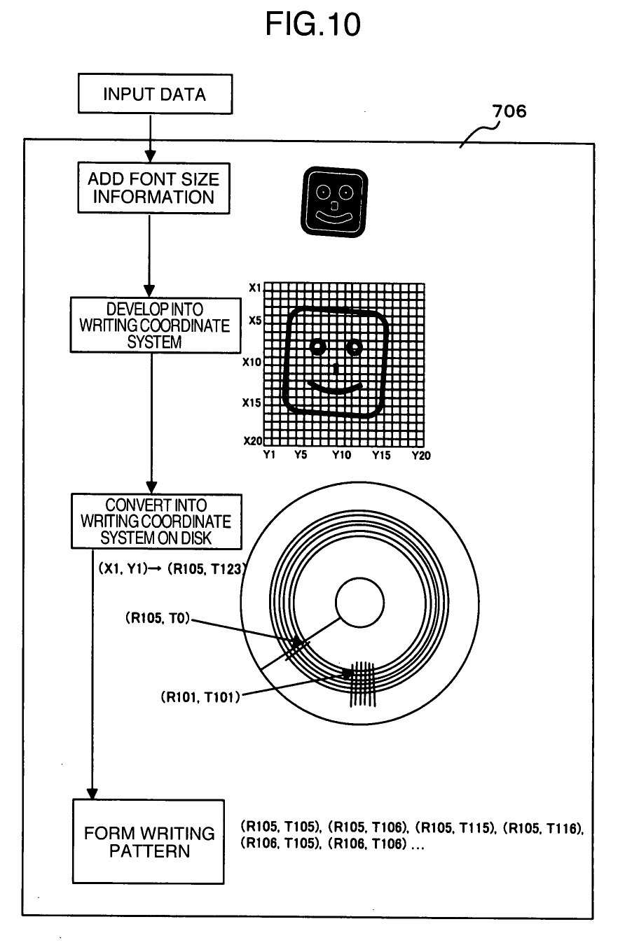

FIG. 10 is an illustrative diagram showing the details of a process to be executed by the encoder 706. Figure writing data (in the example shown, “a mark like a smiling face”) is added to the monitor mark recording condition, developed in a figure writing coordinate system, and transformed into the real figure writing coordinate system on the disk. For example, the “mark like a smiling face” is developed in the X-Y coordinate system having X-axis coordinate values 1 to 20 and Y-axis coordinate values 1 to 20. The mark is written in areas corresponding to (X5, Y5), (X5, Y6) and (X5, Y7) of the coordinate system. A figure writing pattern is formed in accordance with the writing information and the correspondence table between the sector and the figure writing coordinate values described with reference to FIG. 8. In the example shown, in order to make the writing start point (R101 T101) of the figure writing coordinate system on the disc correspond to (X1, Y1) of the figure writing coordinate system, (X5, Y5), (X5, Y6) and (X5, Y7) are converted into (R105, T105), (R105 T106) and (R105, T107).

As shown in the enlarged views of FIGS. 1A to 1C, an area of the set of recorded monitor marks is constituted of a plurality of amorphous areas and crystalline areas. For the purposes of simplicity, although the figure is formed by eight tracks, an area of about 0.01 mm×0.01 mm or large is required to be visually recognized. For example, if an optical disk has a track width of about 0.6 μm, it is necessary to use about 17 tracks or more corresponding to a length of 0.01 mm or longer.

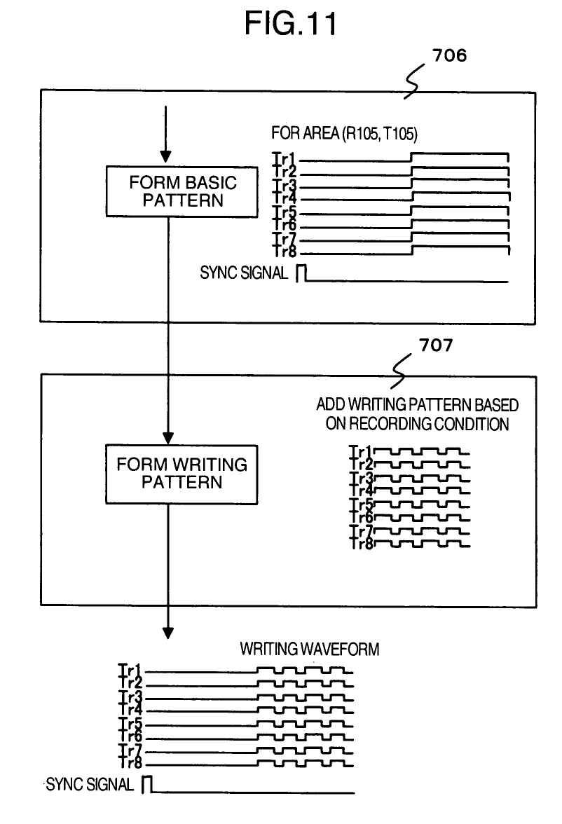

FIG. 11 is a diagram illustrating generation of writing waveforms. In accordance with the correspondence table between the sector and figure writing coordinate values, the encoder 706 of the system controller 703 generates a basic writing pattern from the figure developed in the figure writing coordinate system, in the order of recording and at a timing synchronized with the synchronization signal. FIG. 11 shows by way of example a writing pattern corresponding to the figure writing coordinate values (R105, T105). The pattern generating circuit 707 adds a writing pattern corresponding to the recording condition to form final writing waveforms which are then loaded in the buffer.

In the manner described above, monitor marks for monitoring a deterioration situation can be recorded in a data recording layer of an information recording medium, with an information recording drive, the data recording layer recording data by changing an atomic arrangement through energy radiation. The deterioration situation of data recorded in the information recording medium can be known from how a contrast of the figure changes. By writing monitor marks under the condition that monitor marks are deteriorated faster than the data recorded in the information recording medium, it becomes possible for a user to known deterioration before the recorded data becomes unable to be read, and to use a countermeasure for deterioration, because the monitor marks change before the recorded data is deteriorated.

### Second Embodiment

The second embodiment of the present invention shows examples that a figure as a set of monitor marks floats or changes its shape.

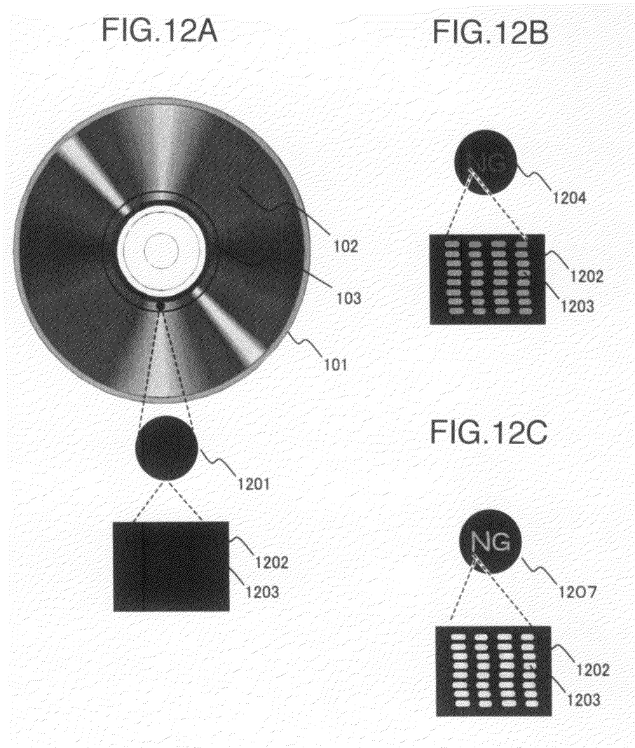

A symbol 1201 is constituted of monitor marks 1202 and 1203 written under different recording conditions, and is completely filled with marks written under at least two recording conditions. Immediately after recording, the figure cannot be visually recognized. After the disk is left about three months, as shown by a symbol 1204 of FIG. 12B, a figure “NG” is visible because of a reflectivity difference between the monitor marks 1203 recorded under the recording condition of easy to deteriorate and the monitor marks 1204 recorded under the recording condition of hard to deteriorate. After the disk is left further one year, a FIG. 1207 shown in FIG. 12C is more clearly visible because of a large reflectivity difference between the monitor marks 1203 recorded under the recording condition of easy to deteriorate and the monitor marks 1202 recorded under the recording condition of hard to deteriorate. By writing the monitor marks under recording conditions providing different deteriorations, it becomes possible to float the figure after deterioration. As compared to the method of erasing the figure after deterioration, this method can judge more clearly the deterioration although it takes a long time to record monitor marks.

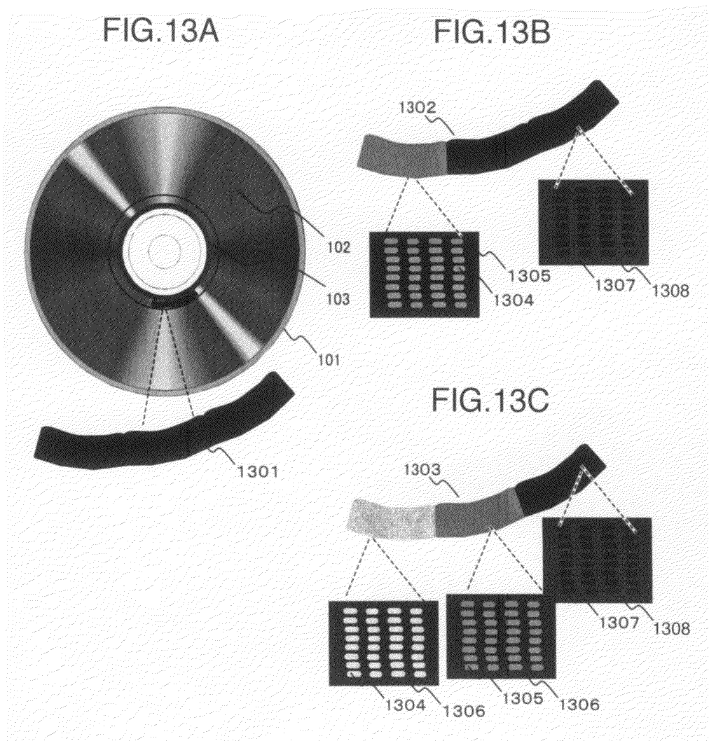

FIGS. 13A to 13C show a case in which monitor marks are written under recording conditions providing different deteriorations, and the figure changes as the deterioration progresses although the figure is not visible immediately after recording. FIG. 13A shows the state immediately after recording, FIG. 13B shows the state after the disk is left three months, and FIG. 13C shows the state after the disk is left one year and six months. A dark color area of a FIG. 1301 changes gradually to a light color area in the order of a FIG. 1302 and a FIG. 1303. A deterioration degree can be known in this manner. If each figure is scaled, it becomes easy to judge deterioration. Although the FIG. 1301 is constituted of monitor marks written under a plurality of types of recording conditions, a difference between the monitor marks cannot be known immediately after recording. As the deterioration progresses, the monitor marks change starting from the monitor marks 1304 written under the recording condition providing easiest deterioration. The shape of the figures is therefore changes. As the deterioration progresses further, the shape of the figures changes further because of a change in monitor marks 1305 written under the recording condition providing second easiest deterioration and a change in monitor marks 1306 written under the recording condition providing third easiest deterioration. An area having a dark color in FIG. 13C is written with monitor marks under the recording conditions 1307 and 1308 providing hard deterioration, so that a change is hard to occur.

With this method, it becomes possible not only to qualitatively judge deterioration but also to quantitatively judge deterioration.

The recording method, medium structure, material, information recording method, information reproducing method, drive and the like not described in the second embodiment are the same as those of the first embodiment.

### Third Embodiment

The third embodiment of the present invention shows an example of the optical disk drive for monitoring a deterioration situation.

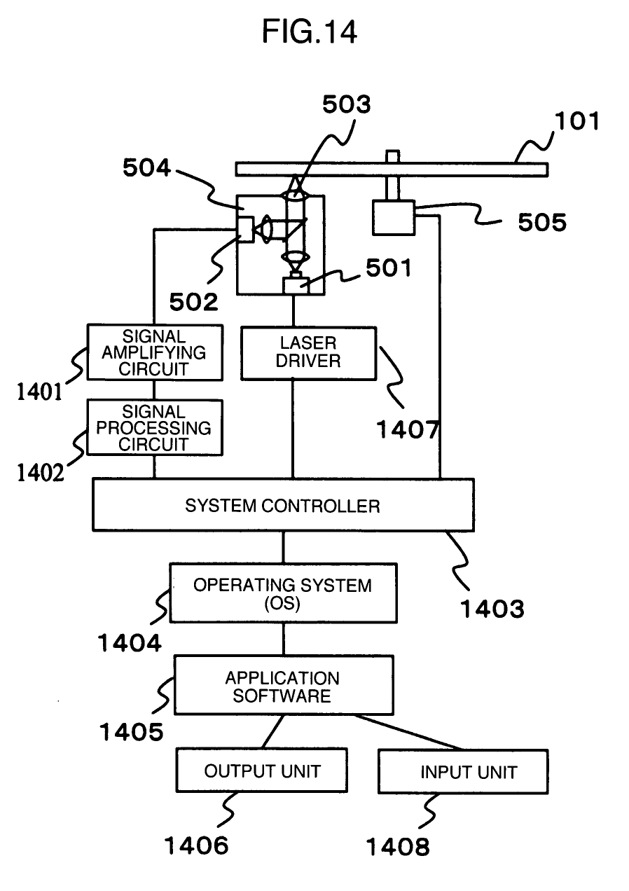

FIG. 14 is a schematic block diagram showing an example of an optical disk drive having a function of monitoring a deterioration situation from monitor marks according to the present invention. For the convenience of description, the drive is shown with the optical disk 101 loaded therein. The optical disk 101 is essential for monitoring the deterioration situation. When necessary, the optical disk 101 may be dismounted from or mounted on the optical disk drive.

The optical disk drive is constituted of: an optical head 504 being movable in a radial direction of the optical disk 101 and equipped with a semiconductor laser 501, a photodetector 502, and an objective lens 503; a motor 505 for driving and rotating the optical disk 101; a laser driver 507 for controlling the semiconductor laser 501 to use it as a monitoring reproduction power; a system controller 1403 for controlling the whole drive; an operating system 1404; application software 1405 and an output unit 1406 for outputting monitor results of monitor marks.

An optical disk is loaded in the optical disk drive having a function of reproducing monitor marks indicating a deterioration situation, and the upper level controller such as the application software 1405 and operating system 1404 sends, via an input unit 1408, a monitor mark reproduction command. Thereafter, the system controller 1403 positions a focal point of the laser beam emitted from the optical head 504 at a proper position of a monitor mark writing layer of the optical disk 101, and controls the laser beam to have a reproduction power to reproduce monitor marks. A default of reproducing monitor marks may be set so that a user is not necessary to enter a command each time the drive is activated.

Signals representative of monitor marks detected with the photodetector 502 are amplified by the signal amplifying circuit 1401 and processed by the signal processing circuit 1402. In accordance with the signal processing results, the system controller 1403 judges a deterioration situation. The system controller has a correspondence table between the signal processing results and a deterioration situation, or has a function of converting the signal processing results into a deterioration situation. As a deterioration situation is judged by the system controller, the deterioration situation judgment results are displayed on the output unit 1406 via the operating system 1404 and application software 1405.

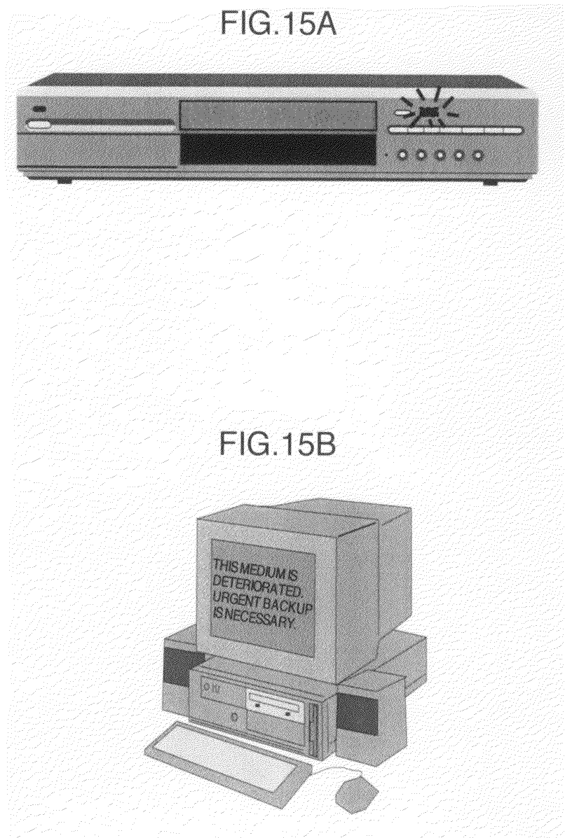

The deterioration situation judgment results may be an alarm display as shown in FIG. 15A or may be displayed on a monitor as shown in FIG. 15B. Any other methods may be used if a user can know a deterioration situation. In addition to providing the deterioration situation judgment results, a unit for a countermeasure for deterioration may be provided so that safety of the data recorded in an information recording medium can be improved and it is convenient for users. The unit for a countermeasure for deterioration may be realized by a function of recording data partially or fully in another area, a function of backing up data in another memory different from the information recording medium which recorded monitor marks, or a function of changing a control method for the recording/reproducing condition when data is recorded next, respectively when it is judged that data is deteriorated. With these functions, data can be held safely without specific consideration of users, and it is very convenient for users. A combination of these functions is more effective.

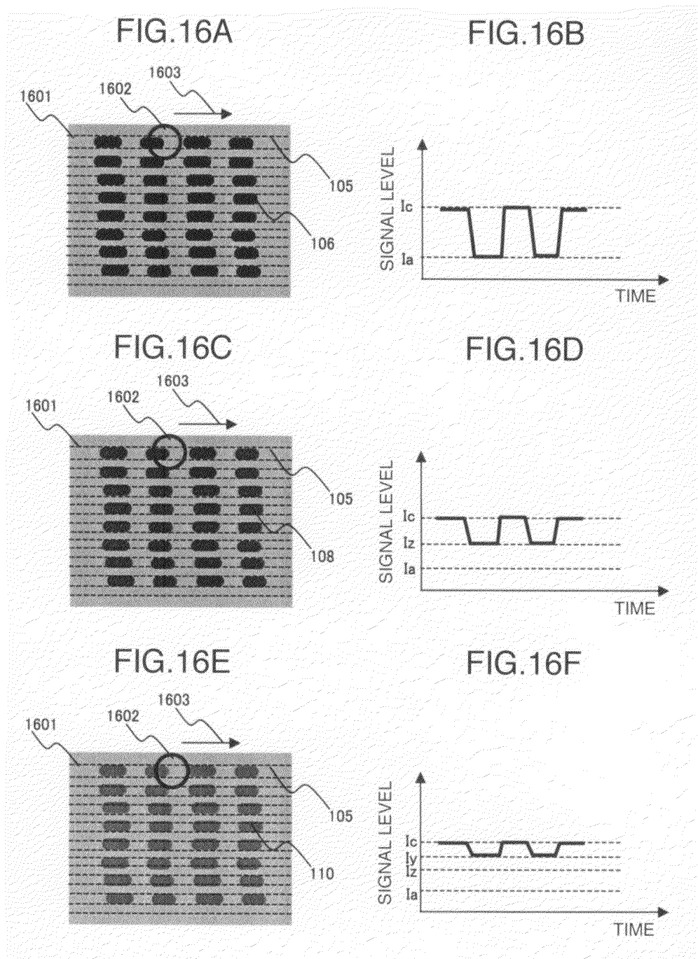

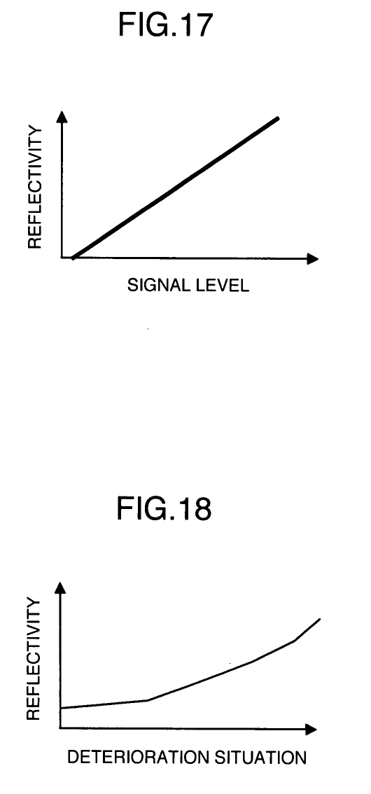

FIGS. 16A to 16F are schematic diagrams illustrating reproduction of the monitor marks shown in FIGS. 1A to 1C. Although not shown in FIGS. 1A to 1C, a tracking pattern 1601 for reproduction is formed generally in parallel to marks. This pattern may be a groove or an uneven pattern having a certain period. As the monitor marks shown in FIG. 16A are reproduced with a laser spot 1602 moving along a running direction 1603, a reproduction signal shown in FIG. 16B is obtained. A detected signal level of an area without a monitor mark is Ic, and a detected signal level of a monitor mark is Ia. A signal level and a reflectivity have a linear relation such as shown in FIG. 17. Since both the signal level and reflectivity change with a deterioration situation, the deterioration situation can be known. FIG. 16D shows a reproduction signal of the monitor marks deteriorated a little as shown in FIG. 16C. The signal level of an area without a monitor mark remains at Ic, and a signal level of the monitor mark is Iz changed from the initial level Ia. FIG. 16F shows a reproduction signal of the monitor marks deteriorated further as shown in FIG. 16E. The signal level of an area without a monitor mark remains at Ic, and a signal level of the monitor mark is Iy changed further from the signal level Iz. A signal level of a monitor mark changes with the deterioration situation. FIG. 18 shows the relation between the reflectivity and deterioration situation. As the deterioration situation progresses, the signal level and reflectivity are increased. It is possible to judge the deterioration situation from the signal level and reflectivity.

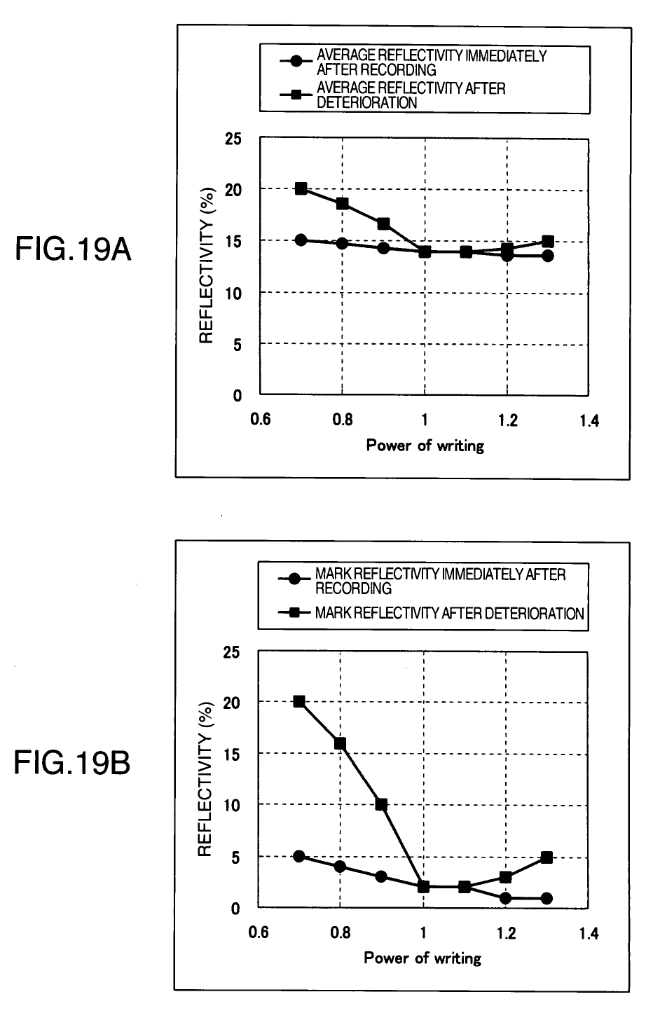

FIG. 19A shows a change in an average reflectivity of marks and areas without marks immediately after recording and after deterioration, and FIG. 19B shows a change in a reflectivity of a monitor mark. The abscissa represents a ratio relative to an optimum power normalized as “1” for recording data in th data recording layer. As seen from these graphs, if a recording power is near the optimum power, the reflectivity does not change even after deterioration. At a recording power of 0.9 or smaller or 1.2 or larger, the reflectivity changes after deterioration. If the reflectivity is to be monitored, the preferable conditions are 0.8 or smaller.

It can be understood that a deterioration situation can be judged by detecting a reflectivity because the reflectivity changes after deterioration if monitor marks are recorded under the condition providing deterioration. The signal level and reflectivity may be those of the monitor marks, or the signal level and reflectivity may be average values of those of the monitor marks and areas without monitor marks. It can also be understood that the degree of deterioration changes with the condition such as a recording power. By checking the deterioration situation by recording monitor marks under the condition providing easier deterioration than data and reproducing the monitor marks, it becomes possible to notify a user of deterioration before data is deteriorated. By recording monitor marks under a plurality of conditions providing different deteriorations, it becomes possible to know stepwise the deterioration situation.

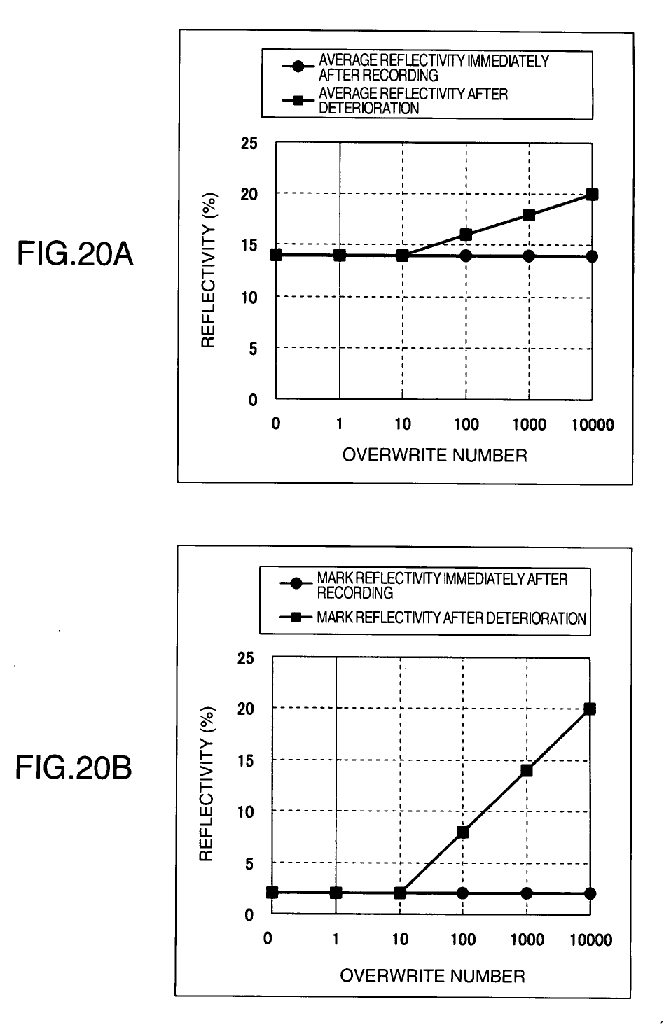

FIG. 20A shows a change in an average reflectivity of monitor marks and areas without monitor marks immediately after recording and after deterioration, and FIG. 20B shows a change in a reflectivity of a monitor mark. The abscissa represents the number of overwrite times. It can be understood from these graphs that at the number of overwrite times of “100” or larger, the reflectivity changes after deterioration. If the reflectivity is to be monitored, the preferable conditions are “1000” times or more.

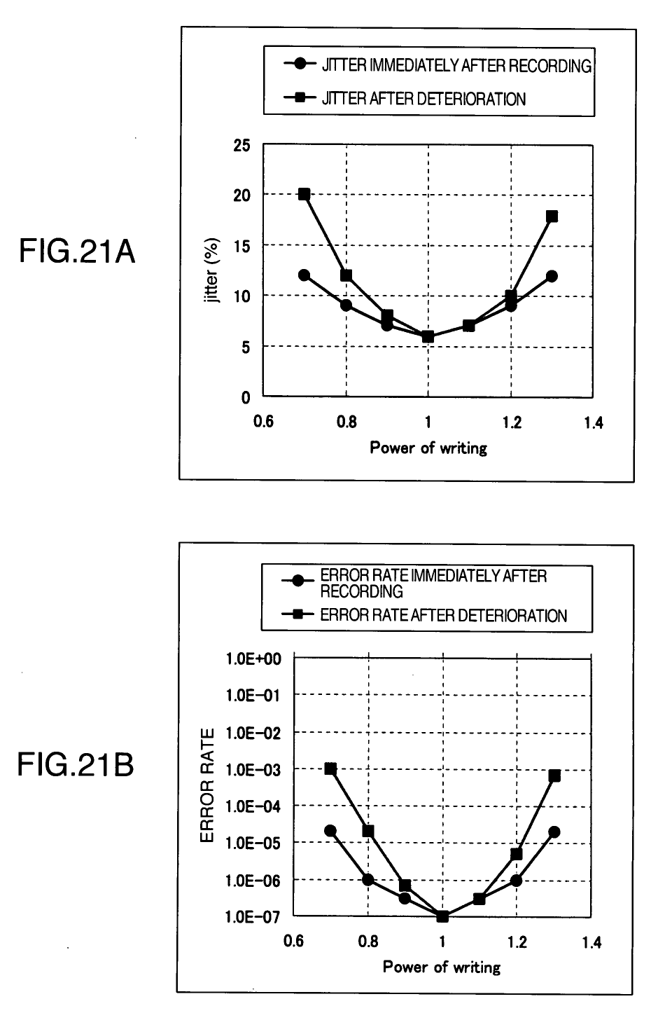

FIG. 21A shows a jitter immediately after recording and after deterioration, the jitter being a fluctuation of an edge of a monitor mark, and FIG. 21B shows a change in an error rate of monitor marks. The abscissa represents a ratio relative to an optimum power of “1”.

In order to check the jitter and error rate, a signal amplified by the signal amplifying circuit 1401 shown in FIG. 14 is supplied to the signal processing circuit 1402 which detects a number of edges of marks and statistically processes to obtain a jitter and error rate.

As seen from these graphs, if a recording power is near the optimum power, the jitter and error rate do not change even after deterioration. At a recording power of 0.9 or smaller or 1.1 or larger, the jitter and error rate change after deterioration. If the jitter and error rate are to be monitored, the preferable conditions are 0.8 or smaller and 1.2 or larger. The signal processing circuit for the jitter and error rate becomes more complicated than for the reflectivity. However, even at a change start stage, a large difference can be distinguished so that the jitter and error rate are effective for stepwise deterioration judgment.

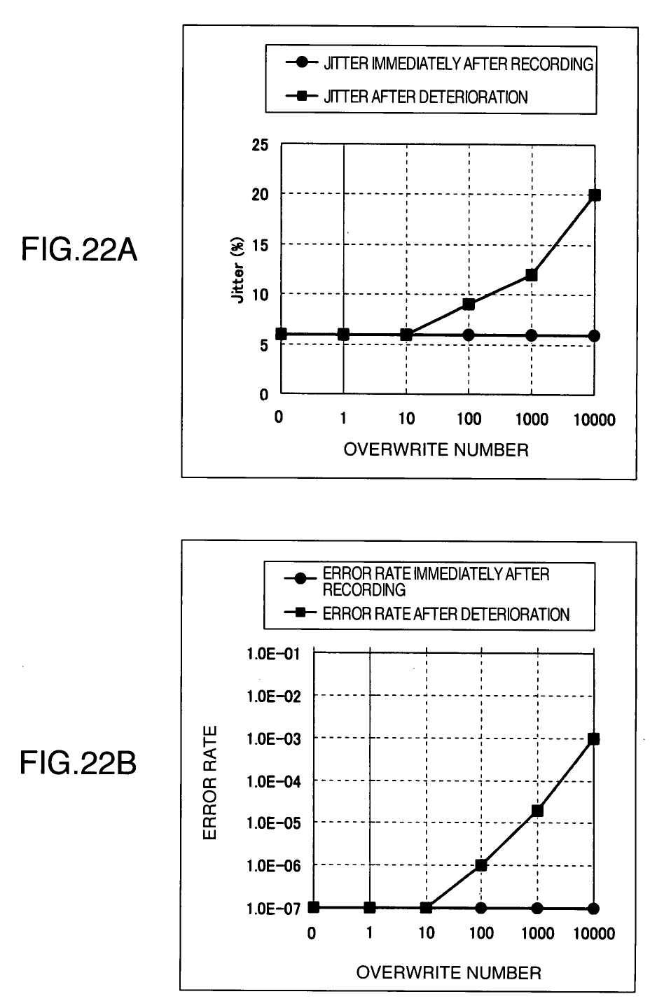

FIG. 22A shows a jitter immediately after recording and after deterioration, the jitter being a fluctuation of an edge of a monitor mark, and FIG. 22B shows a change in an error rate of monitor marks. The abscissa represents the number of overwrite times. It can be understood from these graphs that at the number of overwrite times of “100” or larger, the jitter and error rate change after deterioration. If the jitter and error rate are to be monitored, the preferable conditions are “1000” times or more.

By recording monitor marks under a plurality of conditions providing different deteriorations, differences between both the jitters and error rates may be used for deterioration situation judgment. In this case, judgment can be performed without relying upon the deterioration judgment criterion in the information recording drive.

When the monitor marks are judged by using the optical disk drive, it is not necessary to write a set of a number of monitor marks as in the case of visual recognition. It is sufficient if at least about ten monitor marks are recorded. Therefore, only a very small area suffices. As the number of monitor marks increases, e.g., about 1000 monitor marks, a judgment precision is improved.

As described above, it is possible to judge a deterioration situation of data recorded in an information recording medium by checking the reflectivity of monitor marks and the level and quality of a reproduction signal such as the jitter and error rate.

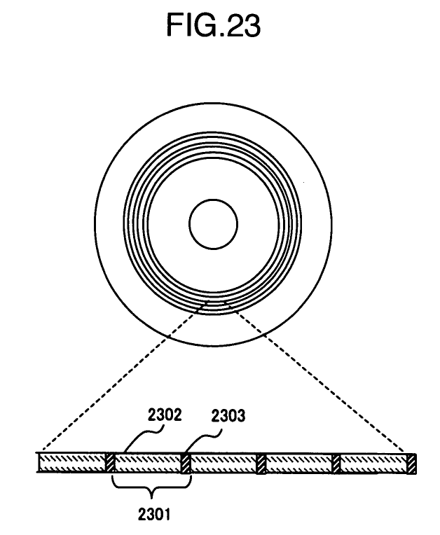

The monitor marks may be recorded in an area different from the data area, such as innermost and outermost circumferential areas, or may be recorded near the data area as shown in FIG. 23. In this case, data 2302 and monitor marks 2303 are both recorded in the same sector 2301, and recording and detecting the monitor marks can be performed at the same time when data is recorded and reproduced, resulting in a reduction in a recording/reproducing time.

The recording method, medium structure, material, information recording method, information reproducing method, drive and the like not described in the third embodiment are the same as those of the first and second embodiments.

### Fourth Embodiment

The fourth embodiment of the present invention shows an example of recording monitor marks in an optical disk having a dye based recording film. A reflectivity of a recording film made of phase-change material changes with an atomic arrangement change from crystalline to amorphous, and a reflectivity of a dye based recording film changes with an atomic arrangement change which breaks some dye couplings. Therefore, the deterioration situation can be checked by a method similar to the method described above.

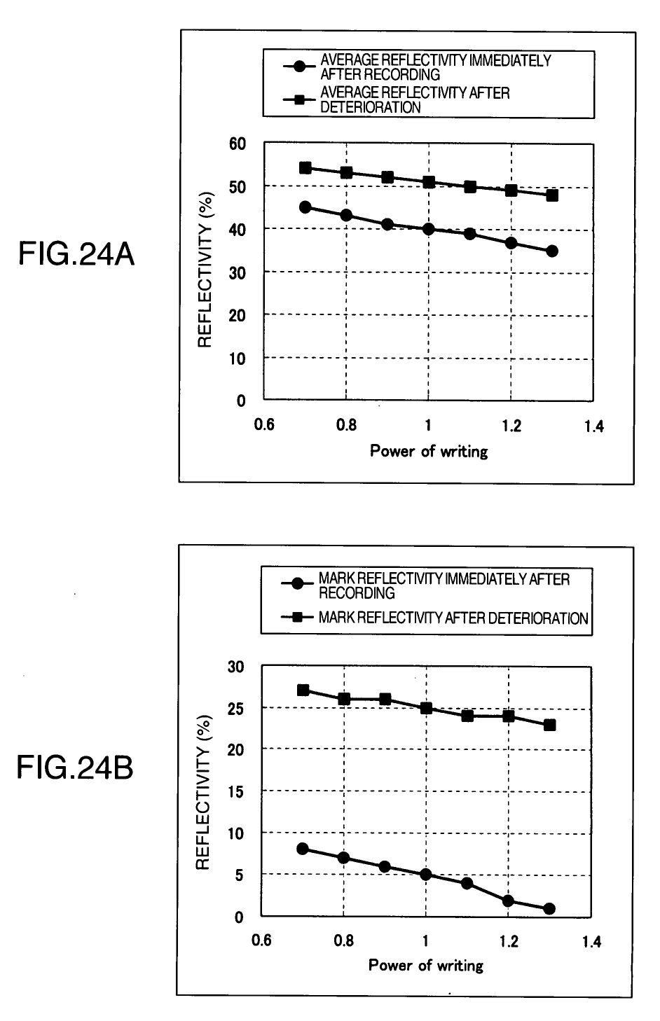

FIG. 24A shows a change in an average reflectivity of monitor marks and areas without monitor marks immediately after recording and after deterioration, and FIG. 24B shows a change in a reflectivity of a monitor mark. The abscissa represents a ratio relative to an optimum power of “1”.

As seen from these graphs, the reflectivity was changed under all recording power conditions. The larger the difference, the higher the recording power was.

In the case of a dye based recording film, deterioration was found even if the recording power was near the optimum value. This may be ascribed to that the recording film has a higher absorption factor than the phase-change material, and the average reflectivity and mark reflectivity is likely to change under the poor environment such as exposure to sun light.

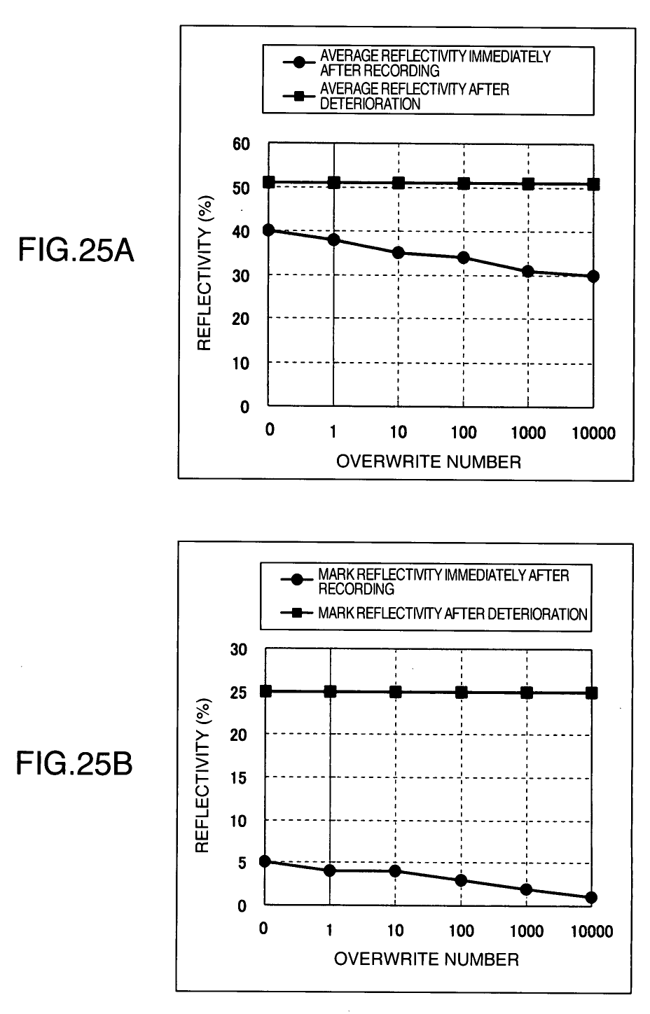

FIG. 25A shows a change in an average reflectivity of monitor marks and areas without monitor marks immediately after recording and after deterioration, and FIG. 25B shows a change in a reflectivity of a monitor mark. The abscissa represents the number of overwrite times. As seen from these graphs, as the number of overwrite times increases, a change in the reflectivity by deterioration becomes large. In the case of a dye based recording film, deterioration was detected even at the number of overwrite times of “0”, i.e., by one recording. If the reflectivity is monitored, the preferable conditions are “1000” times or more because a detection sensitivity is good at a change of 20%.

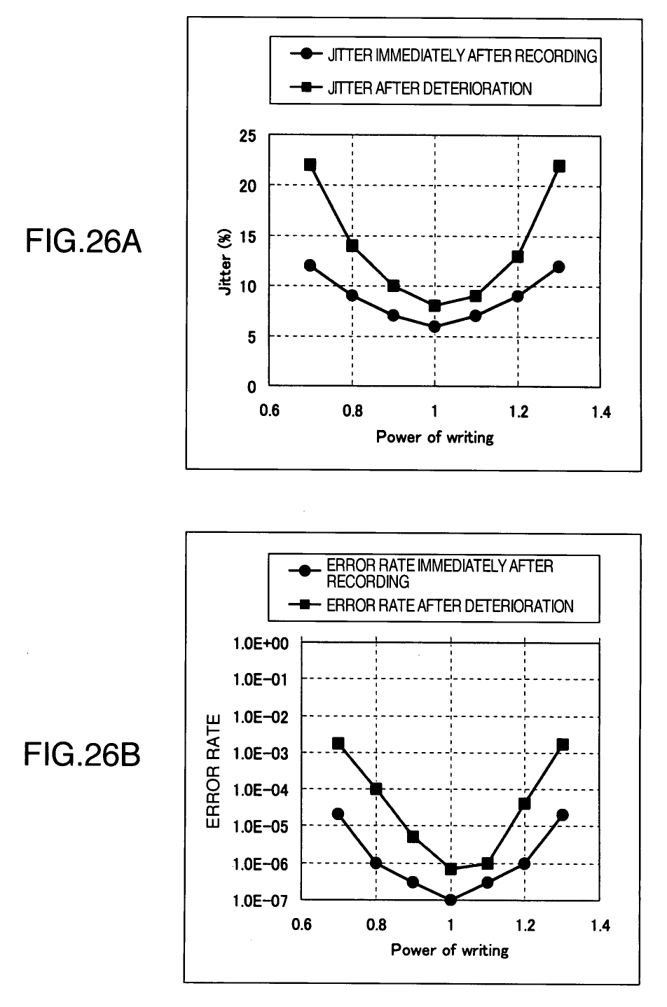

FIG. 26A shows a jitter immediately after recording and after deterioration, the jitter being a fluctuation of an edge of a monitor mark, and FIG. 26B shows a change in an error rate of monitor marks. The abscissa represents a ratio relative to an optimum power of “1”. As seen from these graphs, the reflectivity was changed under all recording power conditions. The larger the difference, the higher the recording power was.

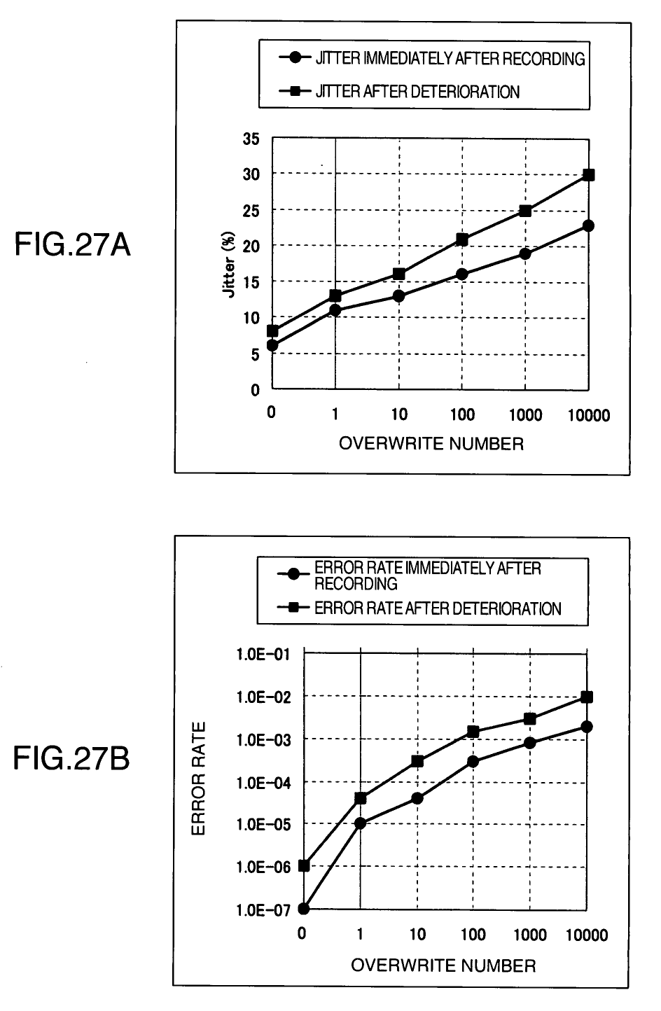

FIG. 27A shows a jitter immediately after recording and after deterioration, the jitter being a fluctuation of an edge of a monitor mark, and FIG. 27B shows a change in an error rate of monitor marks. The abscissa represents the number of overwrite times. As seen from these graphs, as the number of overwrite times increases, a change in the reflectivity by deterioration becomes large. In the case of a dye based recording film, deterioration was detected even at the number of overwrite times of “0”, i.e., by one recording.

By recording monitor marks under a plurality of conditions providing different deteriorations, differences between both the jitters and error rates may be used for deterioration situation judgment. In this case, judgment can be performed without relying upon the deterioration judgment criterion in the information recording drive.

The recording method, medium structure, material, information recording method, information reproducing method, drive and the like not described in the fourth embodiment are the same as those of the first to third second embodiments.

It should be further understood by those skilled in the art that although the foregoing description has been made on embodiments of the invention, the invention is not limited thereto and various changes and modifications may be made without departing from the spirit of the invention and the scope of the appended claims.

1. An information recording drive for forming record marks by energy irradiation to record information in a data recording layer of an information recording medium, the information recording drive comprising:
means for recording monitor marks in said data recording layer, said monitor marks indicating a deterioration situation of said record marks.

2. The information recording drive according to claim 1, wherein said record marks are formed by changing an arrangement of atoms in said data recording layer of aid information recording medium.

3. The information recording drive according to claim 2, wherein said monitor mark recording means has a function of recording said monitor marks under a recording condition providing easier deterioration than said record marks.

4. The information recording drive according to claim 3, wherein said monitor mark recording means has beforehand a recording condition for said monitor marks.

5. The information recording drive according to claim 3, wherein said monitor mark recording means determines a recording condition for said monitor marks by recording learning after said information recording medium is set.

6. The information recording drive according to claim 3, wherein said monitor mark recording means has a function of recording said monitor marks after a number of overwrite times after recording information in said data recording layer of said information recording medium.

7. The information recording drive according to claim 3, wherein said monitor mark recording means has a function of recording said monitor marks at 0.9 or smaller or at 1.2 or larger than a recording power when information is recorded in said data recording layer of said information recording medium.

8. An information recording medium forming record marks by energy irradiation and recording information in a data recording layer, wherein:
monitor marks are being recorded in said data recording layer, said monitor marks indicating a deterioration situation of said record marks.

9. The information recording medium according to claim 8, wherein said record marks are formed by changing an arrangement of atoms in said data recording layer.

10. The information recording medium according to claim 9, wherein a recording situation of said monitor marks is a situation easier to deteriorate more than a recording situation of said record marks.

11. The information recording medium according to claim 9, wherein a recording condition for said monitor marks is recorded beforehand.

12. The information recording medium according to claim 11, wherein the recording condition for said monitor marks is recorded in uneven bits.

13. The information recording medium according to claim 8, wherein a jitter or an error rate of said monitor marks change with deterioration of said record marks.

14. The information recording medium according to claim 8, wherein a set of said monitor marks constitutes a figure, code, a symbol or a letter, or a combination thereof.

15. A deterioration situation detection method for an information recording medium, comprising:
means for detecting a difference between recording situations of record marks formed in a data recording layer through a change in atom arrangement and monitor marks formed in said data recording layer and indicating a deterioration situation of said record marks.

16. The deterioration situation detection method for an information recording medium including said record marks, said monitor marks and spaces where said record marks are not formed, according claim 15, comprising:
means for measuring a reflectivity of said monitor marks and a reflectivity of said spaces by irradiating energy to said information recording medium; and
means for detecting a difference between said reflectivity of said monitor marks and said reflectivity of said spaces.

17. The deterioration situation detection method for an information recording medium according to claim 15, wherein:
a set of said monitor marks constitutes a figure, code, a symbol or a letter or a combination thereof; and
the deterioration situation detection method comprises means for displaying a situation that the set of said monitor marks visually appears, disappears, or changes due to deterioration of said record marks.

18. The deterioration situation detection method for an information recording medium according to claim 15, comprising means for displaying said monitor marks or the set of said monitor marks to be visually recognized.

19. The deterioration situation detection method for an information recording medium according to claim 15, comprising display means for displaying said monitor marks or a set of said monitor marks via a display medium, wherein said display means comprises means for magnifying said monitor marks or the set of said monitor marks or means for monitoring a reflectivity distribution of said monitor marks and said spaces.

20. The deterioration situation detection method for an information recording medium according to claim 15, comprising:
means for detecting a deterioration situation of said record marks from a jitter or an error rate of said monitor marks and a jitter or an error rate of said record marks; and
means, responsive to that said record marks indicate deterioration, for notifying the deterioration.

21. A deterioration situation detection method for an information recording medium including record marks formed in a data recording layer through a change in atom arrangement, monitor marks formed in said data recording layer, and spaces where said record marks are not formed, the deterioration situation detection method comprising steps of:
conducting energy radiation to said information recording medium;
measuring a reflectivity of said monitor marks and a reflectivity of said spaces in accordance with reflection by said energy radiation; and
detecting a difference between said reflectivity of said monitor marks and said reflectivity of said spaces.
